(19) United States
(12) Patent Application Publication
(10) Pub. No.: US 2024/0173663 A1
(43) Pub. Date: May 30, 2024

(54) Device and method for separating liquid from a gas and compressor device provided with such a device

(71) Applicant: Atlas Copco Airpower, Naamloze Vennootschap, Wilrijk (BE)

(72) Inventors: Tom POTTERS, Wilrijk (BE); Tom SAENEN, Wilrijk (BE)

(73) Assignee: Atlas Copco Airpower, Naamloze Vennootschap, Wilrijk (BE)

(21) Appl. No.: 18/438,134

(22) Filed: Feb. 9, 2024

(30) Foreign Application Priority Data
Apr. 25, 2019 (BE) 2019/5276

(51) Int. Cl. B01D 51/08; B01D 45/16; B01D 49/00

(52) U.S. Cl. CPC B01D 51/08; B01D 45/16; B01D 49/006

(57) ABSTRACT

A gas compressor apparatus including a liquid-injected gas compressor device having a compressor inlet for receiving a gas and a compressor outlet through which a compressed gas stream flows, the compressed gas stream having liquid droplets therein, and a separator device communicating with the compressor outlet for receiving the gas stream for separating the liquid droplets from the gas stream, the separator device includes two liquid separators arranged in series and configured to allow the gas stream to flow in a connecting element from a separator outlet of the first liquid separator to a separator inlet of the second liquid separator, and means provided on or in the connecting element for creating radial standing waves in the gas stream to cause the liquid droplets therein to fuse together into larger liquid droplets.

### CROSS REFERENCE TO RELATED APPLICATIONS

The present application is a Divisional Application of U.S. application Ser. No. 17/433, 366, filed on Aug. 24, 2021, which is a National Stage of International Application No. PCT/IB2020/052681, filed on Mar. 23, 2020, which claims priority to Belgian Patent Application No. 2019/5276, filed on Apr. 25, 2019, the contents of all of which are incorporated herein by reference in their entireties.

### BACKGROUND OF THE INVENTION

### Field of the Invention

The present invention relates to a device for separating liquid from a gas.

More specifically, the invention is intended, for example, to purify compressed gas from a liquid-injected compressor from the injected liquid, which is contained in the gas in the form of fine drops or mist.

This liquid will typically be water or oil, but the invention is not restricted to that.

### Background

It is known art that for this purpose the exhaust of a compressor is connected to a liquid separator through which the compressed gas is passed to remove the liquid from the gas.

Various types of liquid separators are known, such as cyclone separators, so-called swirl-tubes, inline swirlers, slug dampers, vapor horns or separators that make use of filter media.

It is known art that such separators can very well separate the larger drops of the liquid present from the gas, but that they are inefficient for the smaller drops.

As a result, the gas downstream of the liquid separator still contains a quantity of liquid in the form of very small drops.

Consequently, by guiding the gas through a liquid separator again, not much more or even no liquid would be separated, as the liquid separator will still let the remaining very small drops pass through.

This is, of course, undesirable because ultimately, the aim is to have compressed gas that contains no or almost no liquid anymore, as the liquid still present can cause problems for consumers or the like of the compressed gas.

To ensure that the next liquid separator does have the ability to separate liquid, it must be ensured that the liquid still present in the gas forms larger drops that can be efficiently filtered out of the gas by the liquid separator.

One way to achieve this is to install a long pipe, of several meters long, between both liquid separators. That way the drops will have the time and room to redistribute and reach an equilibrium wherein the drops are fused back together again to form larger drops. This means that the average drop size will be larger.

This has the disadvantage of making the device rather bulky.

Another solution is placing a fog mat between the two liquid separators to allow the small drops to fuse.

This has the disadvantage of introducing a pressure drop across the fog mat. In addition, the fog mat will have to be replaced regularly because it will foul, thus reducing its proper performance.

CN 107.088.344 describes a complex apparatus for fusing small drops of liquid by generating tangential circular cyclone atomization using sound waves.

U.S. Pat. No. 2,369,020 describes a method for separating liquid from a compressed gas by expanding the gas and using the released energy to generate high-frequency pressure waves.

The purpose of the present invention is to offer a solution to at least one of the aforementioned and other disadvantages, by providing a device which will allow the small drops of liquid in a gas to fuse into larger drops, without generating a pressure drop or without the device becoming very bulky.

### SUMMARY OF THE INVENTION

For this purpose, the invention relates to a device for separating liquid from a gas, wherein the device comprises two liquid separators placed in series, wherein the liquid separators are configured to allow a gas stream from an outlet of the first liquid separator to an inlet of the second liquid separator, characterized in that means are provided to create radial standing waves in the gas stream.

An advantage is that by generating radial standing waves in the gas stream, the drops in the gas start to shift to the antinodes of the radial waves.

As a result, they will be able to fuse much faster into larger drops, which will increase the average size of the liquid drops.

The second liquid separator will be able to separate the liquid in the form of the larger drops thus created, which will be much more efficient compared to the situation wherein the liquid is present in smaller drops in the gas.

In other words: the total quantity of liquid that can be separated will now be much higher compared to the situation without the aforementioned means of creating radial standing waves.

Another advantage is that there is no pressure drop due to the radial standing waves.

There will also be no fouling of the aforementioned means and, if desired, these can be integrated into the device.

Preferably, the aforementioned means have the possibility to regulate the frequency of the radial standing waves in order to obtain an optimum result. Such regulation may be realized, for example, on the basis of the humidity of the gas stream or on the basis of the gas stream flow rate, but the invention is not limited to this.

To allow a gas flow from an outlet of the first liquid separator to an inlet of the second liquid separator, typically the aforementioned outlet of the first liquid separator is connected to the aforementioned inlet of the second liquid separator by means of a connecting element.

The connecting element will typically be a pipe or conduit with, for example, a circular flow section or cross-section, but any form of connecting element capable of connecting the outlet of the first liquid separator to the inlet of the second liquid separator is suitable, regardless of the cross-sectional design.

For example, a pipe or conduit with a polygonal cross-section is also possible.

Wherever hereinafter a pipe is referred to, this refers to a general connecting element, which is not limited to a pipe with a circular cross-section.

By generating radial standing waves in the gas stream, the drops in the gas move towards the antinodes of the radial waves, allowing them to fuse more rapidly into larger drops.

The aforementioned pipe should therefore not be longer than strictly necessary for connecting both liquid separators. That will allow a very compact design of the device.

The invention also relates to a compressor device equipped with a liquid-injected compressor element with an outlet for a gas stream of compressed gas and with a device for separating liquid from the compressed gas, wherein the device includes two liquid separators arranged in series, wherein the liquid separators are configured to admit the gas stream from an outlet of the first liquid separator to an inlet of the second liquid separator, characterized in that means are provided to create radial standing waves in the gas stream, between the first and the second liquid separator.

The invention also relates to a method for separating liquid from a gas, wherein the process comprises the guiding of the gas through two liquid separators placed in series, characterized in that the process further comprises the step of generating radial standing waves in the gas, after passing through the first liquid separator.

The advantages of such a method are analogous to the aforementioned advantages of the device according to the invention.

### BRIEF DESCRIPTION OF THE DRAWINGS

With a view to better demonstrating the characteristics of the invention, a number of preferred variants of a device and method according to the invention for separating a liquid from a gas are described below, as example without any restrictive character, with reference to the accompanying drawings wherein:

FIG. 1 schematically depicts a compressor device provided with a device based on the invention for separating liquid from a gas;

FIG. 2 depicts the cross-section according to line II-II in FIG. 1;

FIG. 3 depicts the cross-section according to line III-III in FIG. 1;

FIG. 4 depicts a variant of FIG. 3; FIG. 5 depicts a variant of FIG. 1.

### DETAILED DESCRIPTION OF THE INVENTION

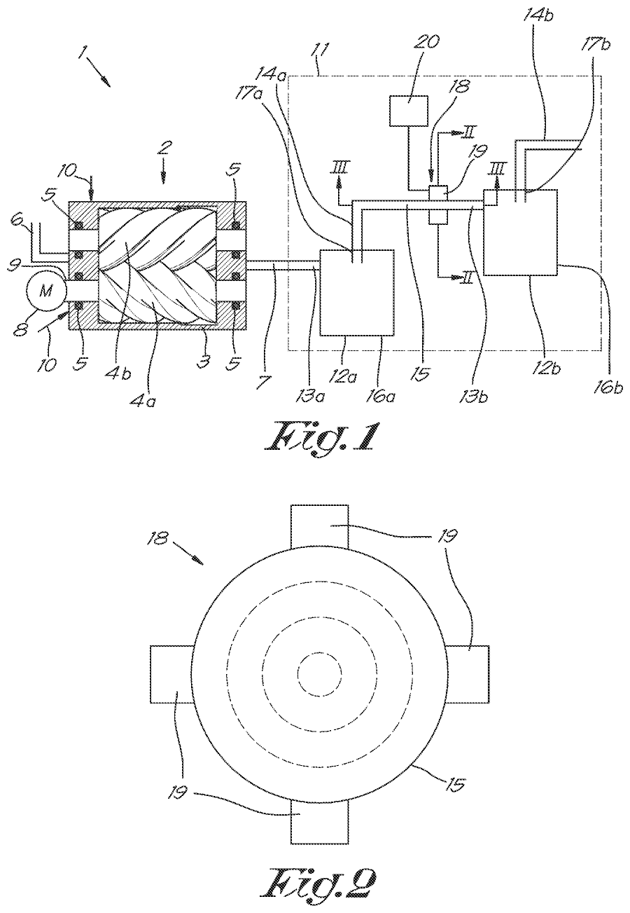

The compressor device 1 schematically shown in FIG. 1 comprises a compressor element 2, which in this case is an oil-injected screw compressor element 2. It is also possible to inject a liquid other than oil, e.g. water, or to use another type of compressor element 2 that is not of the screw type.

As is known art, compressor element 2 comprises a housing 3 containing, in this example, two collaborating screw rotors 4a, 4b, which are rotatably provided through bearings 5.

Housing 3 is provided with an inlet 6 for sucking in gas, e.g. air, and an outlet 7 for compressed gas.

Compressor unit 1 is further provided with a drive 8, e.g. an electric motor, which is coupled to the shaft 9 of one of the screw rotors 4a to drive it. Obviously, any type of drive may be used.

The second screw rotor 4b will typically be driven by the first screw rotor 4a.

The figure also schematically provides a number of injection points 10 for oil. Obviously, these injection points 10 are depicted for illustrative purposes only and do not constitute any limitation for the invention. It is not ruled out either, according to the invention, that a liquid other than oil may be injected.

Typically, there will be an injection of oil in the housing 3 for cooling, lubricating and sealing the screw rotors 4a, 4b, and possibly at the location of the bearings 5.

The outlet 7 of the compressor element 2 is connected to a device 11 according to the invention.

This device mainly comprises two liquid separators 12a, 12b, arranged in series.

The outlet 7 of the compressor element 2 is connected to an inlet 13a of the first liquid separator 12a.

An outlet 14a of the first liquid separator 12a is connected to an inlet 13b of the second liquid separator 12b by means of a connecting element 15. The connection element 15 allows a gas stream from the outlet 14a of the first liquid separator 12a to the inlet 13b of the second liquid separator 12b.

In this case the connecting element 15 is a pipe with a circular cross-section. However, the invention is not limited to this and the pipe could also have a different cross-section.

Outlet 14b of the second liquid separator 12b can in turn be connected to, for example, a compressed air network to which several users of compressed air are connected.

In the embodiment depicted, the second liquid separator 12b is a so-called cyclone separator and this second liquid separator 12b comprises a housing 16b, wherein one end 17b of the pipe at the outlet 14b extends over a certain distance into the housing 16b. This end 17b is also known as the ‘vortex finder’. The aforementioned certain distance should preferably be approximately equal to the diameter of the aforementioned pipe.

In this case both the first and second liquid separator 4a, 4b, are cyclone separators.

Although, in the depicted example, the device 11 comprises only two liquid separators 12a, 12b, it is not ruled out that the device 11 is provided with more than two liquid separators 12a, 12b, all of which are placed in series.

According to the invention, means 18 to create radial standing waves are provided in the pipe. In other words, the means 18 will generate standing waves in gas contained in the pipe or in the gas stream flowing through the pipe.

These radial standing waves are preferably ultrasonic radial standing waves, so that in this case they will not generate any disturbing audible noise.

Obviously, it is not ruled out that standing waves are generated with a lower frequency.

The aforementioned means 18 may be realized in different ways.

In this case, the aforementioned means comprise a number, in this case four, piezo actuators 19.

It is not ruled out that there may be fewer or more than four such piezo actuators 19.

Instead of piezo actuators 19, the means 18 may also comprise one or more electromagnets.

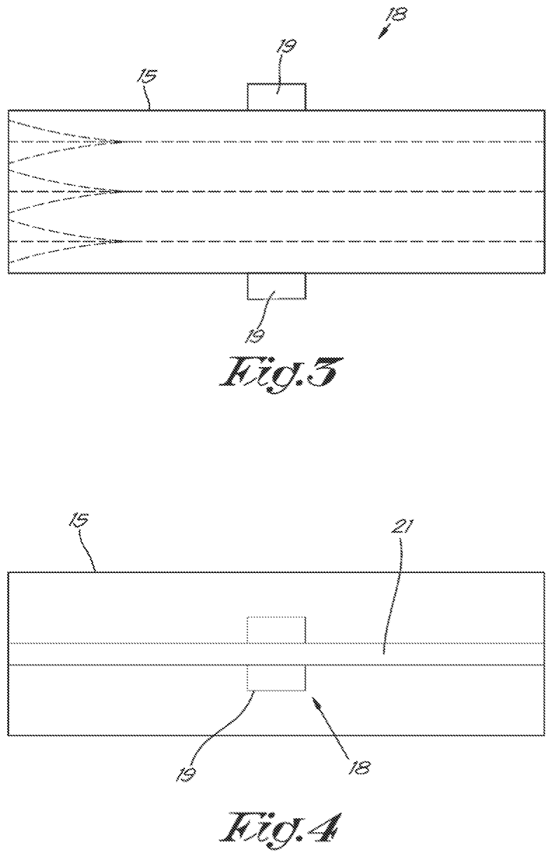

As appears from FIG. 2, the means 18 in the depicted example are mounted on the aforementioned pipe.

In this case it has been ensured that they are mounted symmetrically on the pipe.

In case more than two liquid separators 12a, 12b, are placed in series, for each pipe between two consecutive liquid separators 12a, 12b, means 18 will be provided to generate radial standing waves in the pipe.

The device 11 is also provided with a control unit 20 to control the aforementioned means 18. In this case this can be the control of, e.g., the frequency of the generated radial standing waves.

The operation of compressor device 1 is very simple and as follows.

During operation, the drive 8 will rotate the screw rotor 4a and via the synchronization gears the other screw rotor 4b will also be driven with it.

As a result of the rotation of both screw rotors 4a, 4b, it will be possible to compress gas in the common known way.

During operation, a liquid, e.g. oil, will also be injected into the compressor element 2 for cooling, lubrication and sealing.

As a result, oil in the form of drops will be present in the compressed gas which leaves the compressor element 2 through the outlet 7.

The compressed gas is sent to the inlet 13a of the first liquid separator 12a, where a first separation will take place.

The gas that will leave the first liquid separator 12a will still contain a certain amount of oil in the form of small drops.

Then the gas will flow through the pipe to the inlet 13b of the second liquid separator 12b.

In this pipe, radial standing waves will be generated in the gas by means of the piezo actuators 19.

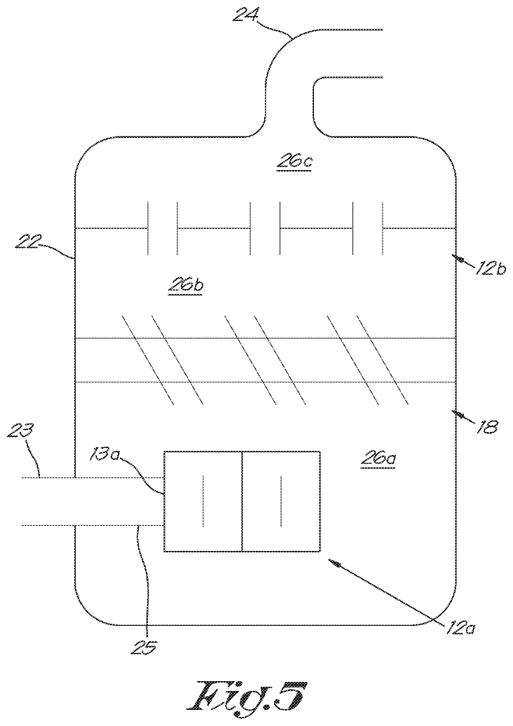

As a result, the small drops will move towards the location of the nodes of the radial standing waves, as shown schematically in FIGS. 2 and 3.

As a result, a kind of cylinder will be formed by the drops stretching out in the longitudinal direction of the pipe.

This way, the small drops have an increased chance to collide with each other, so they will fuse into larger drops.

In other words: due to the increased chance of collision with each other while passing through the pipe, the drops will reach an equilibrium more quickly, i.e. over a shorter period of time or a shorter passage distance through the pipe, similar to the situation when the gas would be transported through a pipe of several meters long.

The control unit 20 will regulate the frequency of the radial standing waves, so that the optimal distribution of the drops size will be obtained.

The gas with the large drops will reach the inlet 13b of the second liquid separator 12b, while this second liquid separator 12b will be able to separate the liquid from the gas with a similar or almost similar efficiency as during the passage of the gas through the first liquid separator 12a.

There will be hardly any or no more liquid left in the gas that leaves the second liquid separator 12b through the outlet 14b.

Typically, when passing through the first liquid separator 12a, if this relates to a cyclone separator, at least 99.9% of the liquid present will be separated. In other words, an efficiency of at least 99.9% is achieved. This means that no more than 0.1% of the total liquid quantity remains in the gas.

When passing through the second liquid separator 12b, an efficiency of 99.9% will again be achieved. This means 99.9% of the remaining liquid will be removed so that a total of 0.0001% of the total liquid quantity remains in the gas.

This very pure gas can then be fed into the consumer network.

FIG. 4 shows a variant of FIG. 3, wherein in this case the aforementioned means 18 are not placed along the outside of the pipe, but the aforementioned means 18 are mounted in the pipe, that is: in the interior of the pipe.

In the pipe a conduit 21 is provided, wherein the means 18 are provided on this conduit 21. These means 18 will excite the conduit 21 in order to generate standing waves in the gas stream through the pipe.

This embodiment has the advantage that the means 18 are shielded or protected by the pipe.

In addition, the operation is analogous to the embodiment described above.

FIG. 5 shows a variant of FIG. 1, wherein in this case the connection between the two consecutive liquid separators 12a, 12b is realized in a different way.

In the aforementioned embodiments the liquid separators 12a, 12b, were configured to allow a gas stream from the outlet 14a of the first liquid separator 12a to the inlet 13b of the second liquid separator 12b with the aid of a connecting element 15 which connects the aforementioned outlet 14a to the inlet 13b.

In this embodiment there is no connecting element 15, but the liquid separators 12a, 12b, are provided in a housing 22 with an inlet 23 for gas to be purified and an outlet 24 for purified gas.

The inlet 23 is connected to the inlet 13a of the first liquid separator 12a via a pipe 25. The outlet 14a of the liquid separator 12a enters a first section 26a of housing 22.

The first section 26a is separated from a second section 26b through means 18 to create radial standing waves in the gas stream.

The second section 26b is separated from a third section 26c by means of the second liquid separator 12b, which connects with its inlet 13b to the second section 26b and connects with its outlet 14b to the third section 26c.

This third section 26c is in direct connection with the exhaust 24 of the housing 22.

The gas to be purified enters the first liquid separator 12a through the inlet 23 and the pipe 25, where a first separation will take place.

The gas will then enter the first section 26a, after which it must pass through the means 18 to enter the second section 26b.

When passing through the means 18, the remaining drops will fuse to form larger drops.

When the gas stream has entered the second part 26b, it will have to pass through the second liquid separator 12b, where a second separation will take place, before it can enter the third section 26c and leave the housing 22 through the outlet 24.

Obviously, the aforementioned means 18 in this embodiment can be implemented in various ways.

Although in the depicted example both the first and second liquid separators are cyclone separators, this is not necessary for the invention. The first liquid separator may also be another type of liquid separator, which does a (rough) pre-separation. The second liquid separator may also be another type of liquid separator, which does a (fine) liquid separation. In that case, the second liquid separator is preferably, but not necessarily a filter.

The present invention is by no means limited to the embodiments described as examples and shown in the figures, but a similar device and method according to the invention for separating a liquid from a gas according to the various variants can be realized without going beyond the scope of the invention.

1. A gas compressor apparatus, comprising:
a liquid-injected gas compressor device having a compressor inlet for receiving a gas and a compressor outlet through which a compressed gas stream flows, the compressed gas stream having liquid droplets therein; and
a separator device communicating with the compressor outlet for receiving the gas stream for separating the liquid droplets from the gas stream,
the separator device comprising:
two liquid separators arranged in series and configured to allow the gas stream to flow in a connecting element from a separator outlet of the first liquid separator to a separator inlet of the second liquid separator, and
means provided on or in the connecting element for creating radial standing waves in the gas stream to cause the liquid droplets therein to fuse together into larger liquid droplets.

2. The compressor apparatus according to claim 1, wherein the means creates ultrasonic radial standing waves in the gas stream.

3. The compressor apparatus according to claim 1, wherein the means comprises one or more piezo actuators and/or solenoids.

4. The compressor apparatus according to claim 1, wherein the compressor apparatus is provided with more than two liquid separators, all of which are arranged in series, wherein for every connecting element between two successive liquid separators the means are provided which are configured to generate radial standing waves in the connecting element.

5. The compressor apparatus according to claim 1, wherein the second liquid separator is a cyclone separator.

6. The gas compressor apparatus of claim 1, wherein the compressor device is a screw compressor element.

7. The gas compressor apparatus of claim 1, wherein the compressor device is an oil-injected screw compressor element.
